(19) United States
(12) Patent Application Publication
(10) Pub. No.: US 2010/0296755 A1
(43) Pub. Date: Nov. 25, 2010

(54) STABLE PACKAGE FOR A FLUID MATERIAL AND A METHOD OF PRODUCING THE SAME

(76) Inventor: Vilho Eriksson, Stockholm (SE)

Correspondence Address: DICKSTEIN SHAPIRO LLP, 1825 EYE STREET NW, Washington, DC, 20006-5403, US

(21) Appl. No.: 12/863,623

(22) PCT Filed: Jan. 19, 2009
(86) PCT No.: PCT/SE09/00018

§ 371 Date: Aug. 12, 2010

(30) Foreign Application Priority Data
Jan. 21, 2008 (SE) 0800137-2

(51) Int. Cl. B65D 33/06; B65D 30/10; B31B 1/26

(52) U.S. Cl. 383/12; 383/104; 493/231

(57) ABSTRACT

The invention relates to a package for a fluid material, the package (8) comprising a bag of flexible sheet material (2), where the package (8) comprises two opposite side walls (12, 14) and a bottom (22) which bottom (22) before filling of material presents two fields (18, 20) received between the side walls (12, 14), and where further the bottom (22) and the side walls (12, 14) are tightly sealed with each other along the side edges (3, 5) of the package (8), where a creased section (13, 15) is arranged along the transition edges (50, 52) between the bottom (22) of the package (8) and its respective side walls (12, 14) for forming of a series of to each other connected lamellae (54, 56; 58, 60) whereby the side walls (12, 14) are kept substantially vertical and substantially perpendicular to the bottom (22) along the transition edges (50, 52) when the package (8) is filled with the fluid material (9) wherein the package (8) is stabilised against tipping over. The invention further relates to a method of producing a stabilised package (8).

### TECHNICAL FIELD OF THE INVENTION

The present invention relates to a package for a fluid material, and a method of producing such a package.

### TECHNICAL BACKGROUND

For standing fluid-filled packages of bag-type having a relatively large height, e.g. with a height twice as large as the smallest cross-sectional size, a stability problem has been identified. As packages of the above type are made of thin plastic foil material, the package, when it stands with its flat bottom wall on a horisontal surface, has a tendency to tip over, as the transition area between the side wall and the adjacent bottom wall can not counteract such a tipping over; transition area tends to move upwards along the side wall of the package.

SE 525 077 C2 shows a bag of flexible sheet material with two side walls, which bag before filling it with material is flat, where an elastic string of material defining a stabilising transition between the vertical side wall and the horizontal bottom of a filled bag is connected to each of the side walls at their lower border.

According to the previously known art above, the stability problem is given a solution by that one in the transition line between the respective side wall of the package and the adjacent edge of the bottom wall of the fluid filled package, applies a string of material on the outside of the package. This string supports against the ground and hinders thus the transition line to move upwards along the side wall of the package.

### SUMMARY OF THE INVENTION

One object of the invention is to provide a technique for obtaining stabilising of a flexible plastic foil package for fluid material, e.g. liquid, against tipping over, with a structure that is easier to produce than the known applying of strings mentioned above.

The object is obtained by the invention as defined in the accompanying independent claims.

Embodiments of the invention are shown in the accompanying dependent claims.

### BRIEF DESCRIPTION OF DRAWINGS

FIG. 1 shows in side view a longitudinal part of a device for producing of packages.

FIG. 2 shows schematically a section taken along line II-II in FIG. 1.

FIG. 3 shows schematically a sectioned view taken along line in FIG. 1.

FIG. 4 shows a view taken along line IV-IV in FIG. 1.

FIG. 5 shows schematically in perspective view a fluid filled, but not at the neck sealed package of the kind which is produced according to FIG. 1.

FIG. 6 shows a view taken along line VI-VI in FIG. 5 over the bottom of the fluid filled package.

FIG. 7 shows schematically a cut out longitudinal part over the inside of a package according to FIG. 5, in inclined perspective view.

FIG. 8 shows schematically a with fluid material filled package according to the invention which has been sealed.

FIG. 9 shows a first embodiment of a handle for the package,

FIG. 10 shows a second embodiment of a handle for the package, and

FIG. 11 shows a further embodiment of the lower part of the package.

### DESCRIPTION OF PREFERRED EMBODIMENTS

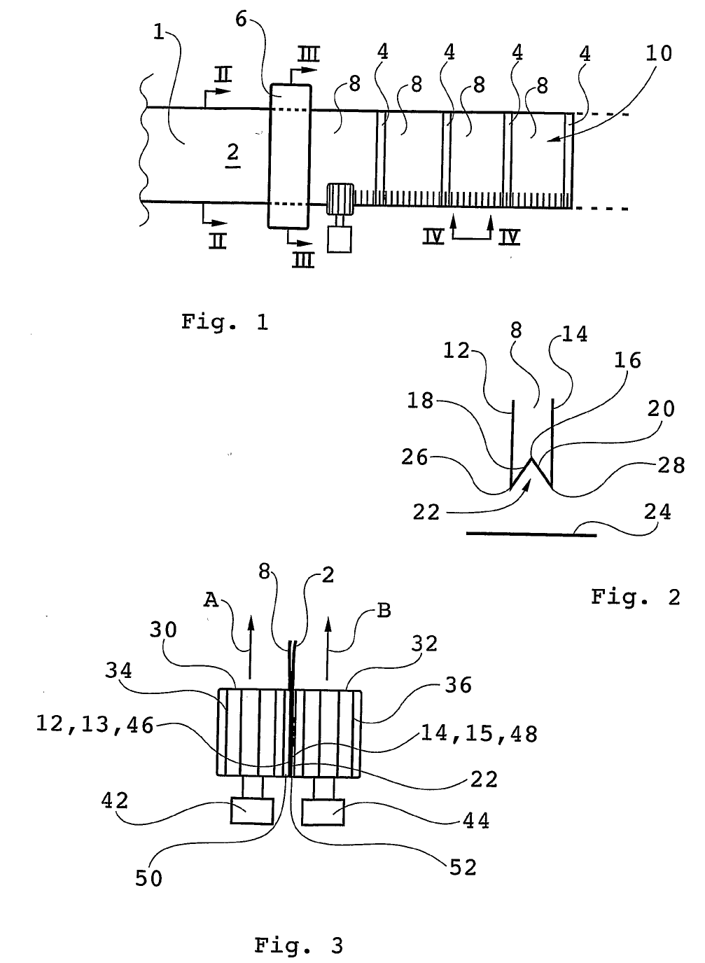

FIG. 1 shows a web 2 of thin plastic foil material or other weldable flexible material 1, which as can be seen from the schematic section according to FIG. 2, is folded to W-profile and laid flat. The web 2 can be assumed to run in its longitudinal direction to the right in FIG. 1 and be arranged with a transversal sealing seam 4, e.g. a welding seam, at regular intervals along the web, using e.g. a co-travelling or stationary welding device 6, e.g. in the form of a pair of welding jaws movable against and away from each other, for by intermittent welding establishing welding line areas at the seams 4 that are situated at a distance from each other along the web 2. With the welding seams 4, is formed a chain of bags 8 laid flat with W-cross-sectional profile and a at the top situated open neck 10, which neck 10 can be sealed in a in itself known way after filling of a bag 8. The individual bags 8 can be separated from each other before or after filling, e.g. with a cut along the center of the width of the respective welding seam 4.

From FIG. 2 it is further understood that the bag 8 at filling with fluid material, e.g. a liquid, will widen in such a way that its both sidewalls 12, 14 mainly are displaced in parallell away from each other, while the between them lying lamellae 18, 20 of the fold 16 forms the filled packages 8 bottom 22 which is flat if the bag 8 lies on a flat, preferably substantially horizontal, ground 24, whereby the transition edges 26, 28 between the side walls 12, 14 and the bottom 22 extends along the surface of the ground 24.

As is shown in FIG. 3, two toothed wheels 30, 32 with parallel axles may have distributed around their cylinder casing toothings 34, 36 such as ribs that extend in parallel with the shafts A, B of the toothed wheels 30, 32. The shafts A, B of the both toothed wheels 30, 32 are arranged in parallel and have associated rotation drives 42, 44. By that the web 2 is arranged to run between the toothed wheels 30, 32 and by that the teeth 34, 36 of the toothed wheels 30, 32 are arranged to come into engagement with each other along a bottom area of the W-shaped web 2, the lower part of the web 2, i.e. the side walls 12, 14 and the bottom 22 of the package 8 are given a zig-zag crease 13, 15 along a lower border area 46, 48 of the web 2 along the transition edges 50, 52 between the bottom 22 of the package 8 and its respective side walls 12, 14.

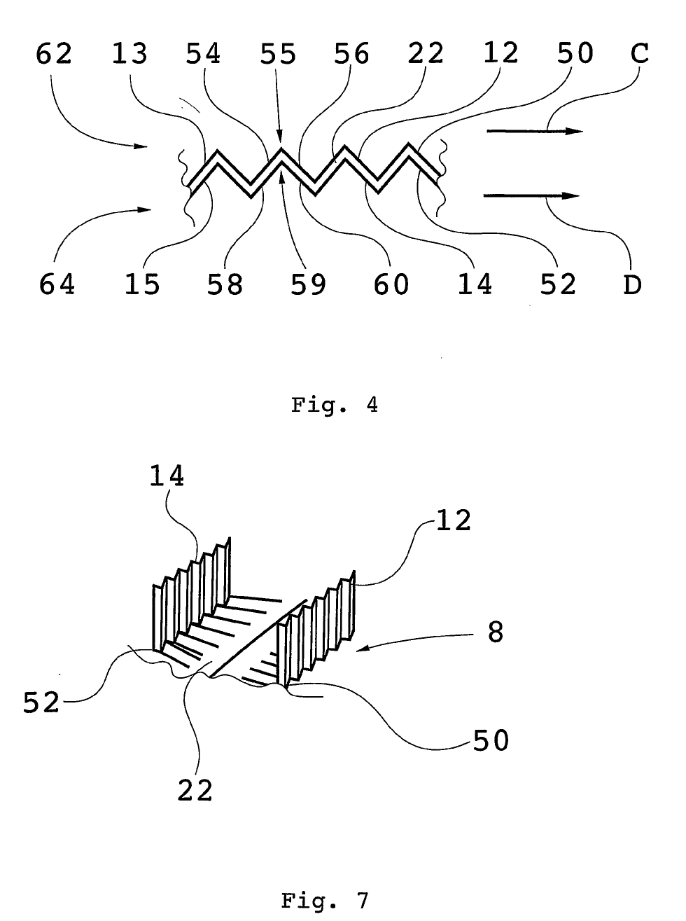

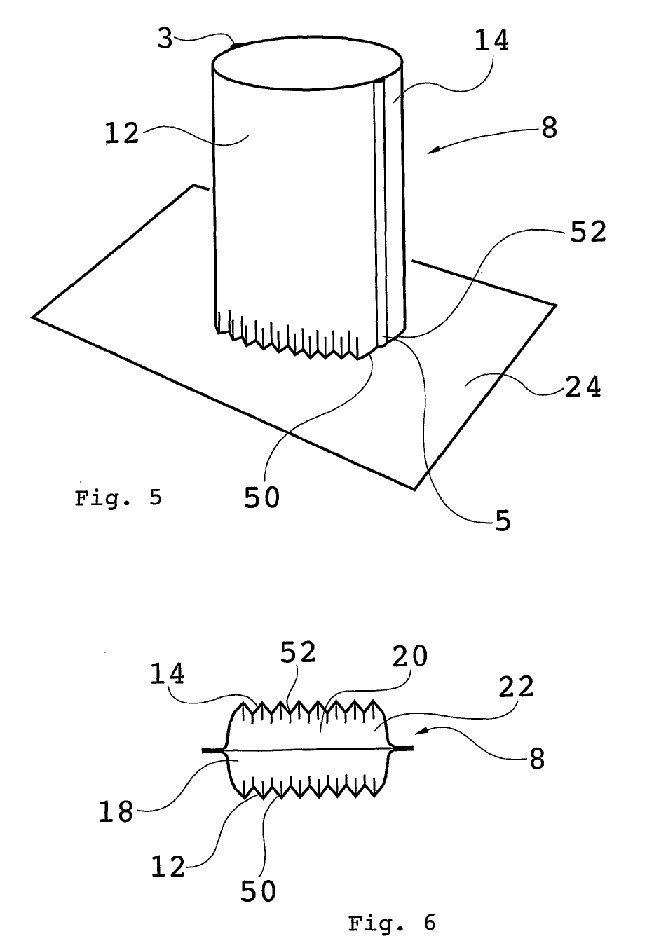

FIG. 4 shows the zig-zag crease 13, 15 of the lower part of the W-shaped web 2. The side walls 12, 14 and the bottom 22 of the package 8 obtains thus a creased section 13, 15 along the transition edges 50, 52 between the bottom 22 of the package 8 and its respective side walls 12, 14 in the form of thin elongated lamellae 54, 56, 58, 60 that in the longitudinal directions C, D of the lamella series 62, 64 are mutually alternatingly creased as will be described closer in FIG. 5. The connection lines 55, 59 between the lamellae 54, 56; 58, 60 of the creases 13, 15 extend preferably with substantially right angles to the transition edges 50, 52 between the bottom 22 of the package 8 and its respective side walls 12, 14 and give thereby the area around the transition edges 50, 52 a substantial stability and stiffening against displacement of the transition between the bottom 22 and the side walls 12, 14 in the vertical direction of the side walls 12, 14 when the package 8 stands on a horisontal ground and is filled with a fluid material such as a liquid. Further, the creased sections 13, 15 give a increased stiffness in bending of the packing material in the direction of the connection lines 55, 59 between the elongated lamellae 54, 56; 58, 60 that are oriented at right angles against the transition edges 50, 52 which gives a spring effect when filling the package that counteracts the above mentioned displacement of the transition between bottom 22 and side walls 12, 14.

In order not to break the material 1 of the web 2 during the creasing operation, the material 1 is preferably heated up in close connection with the creasing operation, e.g. by using heated toothed wheels 30, 32 or by pre-heating of the material 1 before it is creased so that it is in heated state at the creasing operation which is performed using the toothed wheels 30, 32. The material 1 is heated to a temperature below the melting temperature of the material 1, e.g. to the glass transition temperature of the material 1.

Depending on which material 1 is used for the web 2, the material 1 may after cooling have aquired a somewhat harder structure depending on thermic and mechanic influence on the molecules during the working, i.e. one can say that the material 1 has been “cured”.

At the creasing operation preferably at least a part of the lower part of the W-shaped web 2 is creased, e.g. about 75% of the lower edge of each package 8, and preferably in the central area of the lower edge of the package 8, i.e. in the area which is situated at a distance from the transversal sealing seams 4 of the packages 8, but it is also possible to crease the lower part of the W-shaped web 2 in its entire length. The skilled person thus realises that the creasing not necessarily has to extend along the entire length of the web 2 between the sealing seams 4. Preferably, the creasing further extends at least some mm, e.g. at least 3 mm, in the vertical direction of the package 8. The creasing may be performed either before or after the sealing seam welding operation.

After the material 1 has been creased, the web 2 is cut as mentioned above so that individual packages 8 are separated from the web 2 whereafter the packages 8 are filled and sealed. As an alternative, the packages 8 may be filled at least partly before cutting of the web 2.

When the packages 8 are filled with fluid material, they will as mentioned earlier stretch out whereby they obtain the rounded cross-sectional shape shown in FIGS. 5 and 6 by that the bottom 22 is flatly seam welded with the respective side walls 12, 14 in the web 2 laid flat. The bottom lamellae 18, 20 of the package 8 i.e. the bag 8 form the bottom of the filled package which is substantially planar when the bag 8 is put on a substantially flat ground 24 whereby the transition edges 50, 52 between the bottom 22 of the package 8 and its respective side walls 12, 14 (see FIG. 2) will lay in the ground plane along the in the vertical direction of the bag 8 substantially parallel opposite side walls 12, 14. By the above described method the packages 8 obtain a shape of the bottom 22 having six edges.

FIG. 7 shows a perspective view over the inside of a package 8 in the transition edges 50, 52 between the bottom 22 of the package 8 and its respective side walls 12, 14 whereby can be seen how the transitions between the creased bottom 22 and the respective side walls 12, 14 are locked to their positions, and that this gives the package material 1 a marked increase in stiffness in bending in the area closest to the transition edges 50, 52.

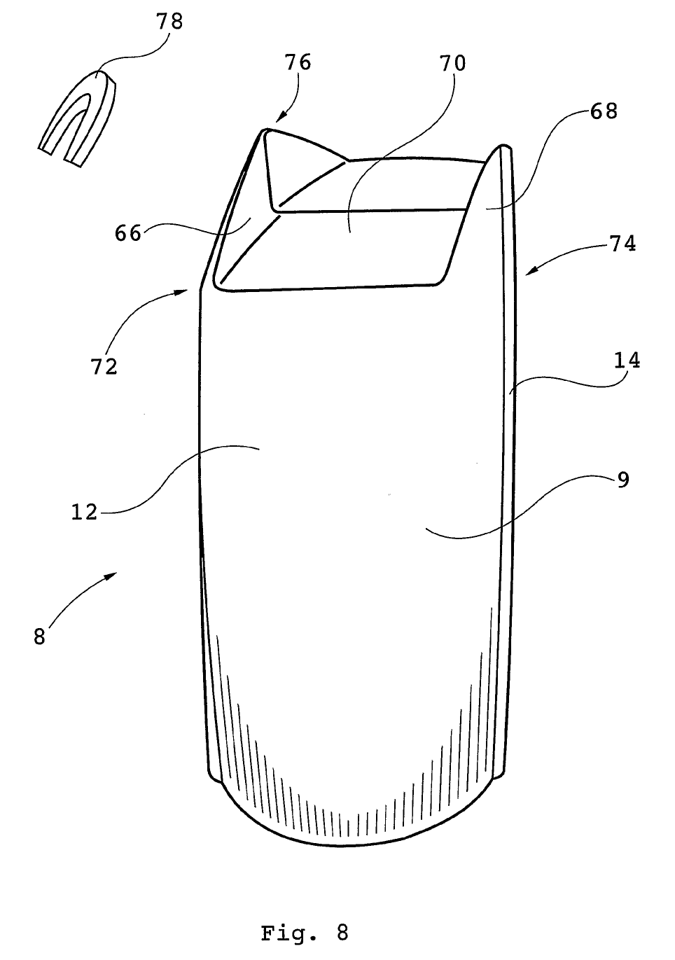

FIG. 8 shows a with fluid material 9 filled package 8 that have been sealed by joining together the upper edges of the side walls 12, 14 with each other e.g. by welding, gluing or similar. The flaps 66, 68, also called delta-corners, that are formed when the upper end of the package 8 is sealed as mentioned above may in several different ways be folded in and fastened to the hereby formed upper surface 70 of the package 8, or against the side envelop surface 72, 74 of the package, in order to additionally stiffen the package 8 and its upper part and to thereby make the package 8 stackable. When one eventually is to empty out the contents one may simply fold out a flap 66, 68 and cut or tear this off whereby one obtains a pouring spout 76 which then may be re-sealed in different ways e.g. with a re-sealing device 78 such as a clamp or similar which may be separated from or fixed to the package 8.

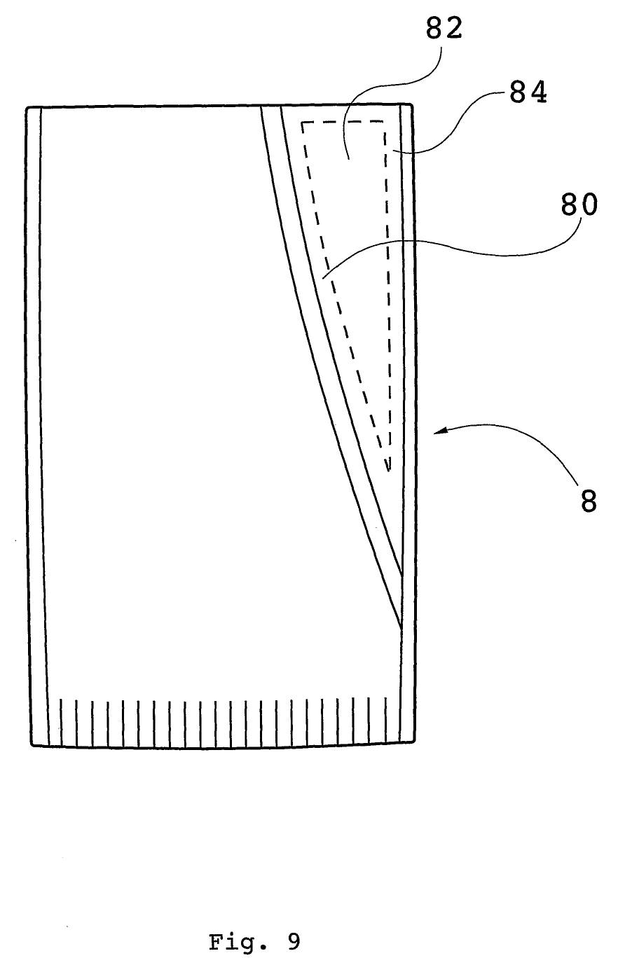

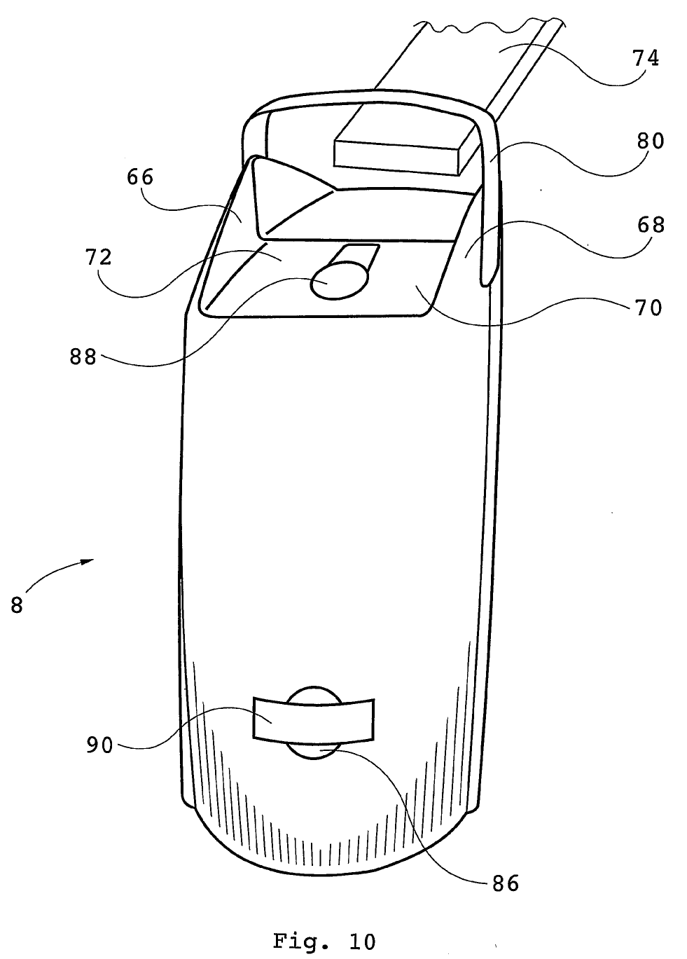

FIG. 9 shows schematically a further embodiment of a package according to the invention, where the package is arranged with a handle 80 in order to facilitate pouring out of the contents 9. As further can be seen from FIG. 9, the package 8 according to this embodiment is arranged sloping shaped so that a handle 80 with an insert 82 in the form of a folded supporting device 82, preferably a folded piece of cardboard, may be inserted in a pocket 84 which is formed on the package 8. The cardboard is folded so that it shows a triangular cross-section seen in a section along the horizontal plane of the package 8 and preferably folded so that one of the sides of the triangle shows double material thickness in order to further stiffen the handle 80.

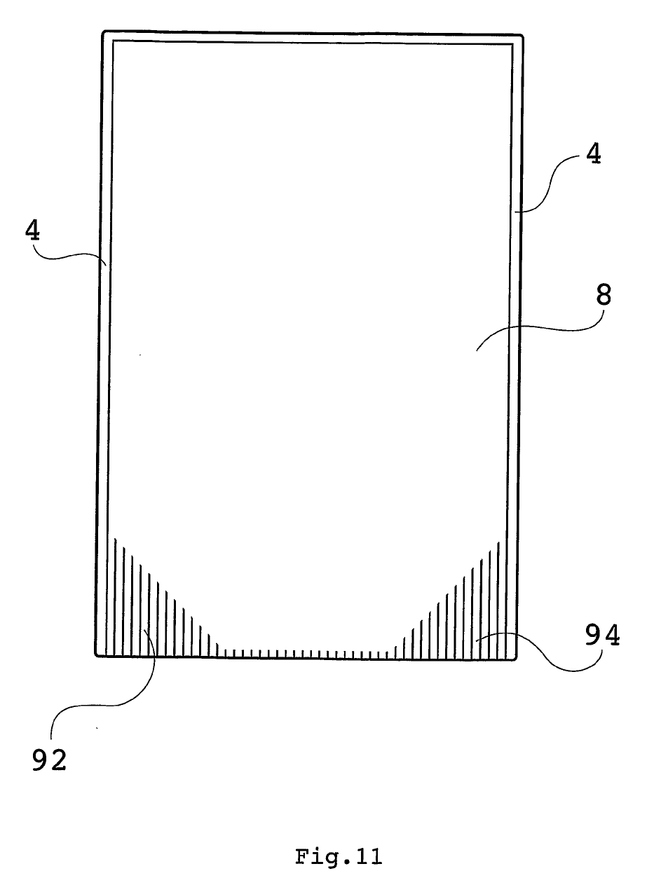

FIG. 10 shows another embodiment of a handle 80 for the package. After filling and sealing of the package 8, the central part 72 of the sealed upper surface 70 of the package 8 can be pressed down using a plate 74 whereby the earlier mentioned flaps 66, 68 on the upper surface 70 of the package rise up. This enables easy attachment of a preferably band-shaped handle 80 at the flaps 66, 68 by gluing, fixing by tape or fixing by melting or in another way. At a package 8 arranged with handle 80 as mentioned above, one of the flaps 66, 68 may as earlier mentioned be removed in order to enable emptying of the package 8, but preferably a separate emptying device 86, 88 is arranged fixed to the package 8. The separate emptying device 86 may e.g. be arranged far down on the side 12, 14 of the package 8 in such a way which is common in “bag-in-box” packages. As an alternative, the emptying device 88 may be a spout with screw cap arranged at the upper part of the package 8, preferably fixed in the opening through which the package 8 is filled. A further advantageous alternative is to arrange the emptying device 86, 88 as a valve of the kind which also is used on air mattresses and bathing toys whereby the valve may be pushed in into the package 8 when not in use. Also, the advantage is attained, that a flat seal 90 of e.g. paper or plastic may be fastened on the package 8 in such a way that it covers the valve in its into the package pushed position. Hereby a buyer of the package 8 may assure that the seal is not broken which means that the valve has not been opened. By arranging a handle 80 as mentioned above, enable stacking and compact transportation of the package 8 as the handle may be “folded down” against the upper surface of the package 8 which then forms a substantially flat surface. Further a package according to the invention demands only very little material in addition to the material which enclose the contents of the package.

FIG. 11 shows a further embodiment of the lower part of the package. It is also possible to, instead of using toothed wheels, to emboss the creasing, or ribbing, with pressing jaws which are moved intermittent against and away from the material web 2 in the same way that the device 6 which produces the sealing seams 4 for the packages 8. As is shown in the figure, when press jaws are used the lower corners of the package may be arranged with ribbings 92, 94 higher up along the side walls 12, 14 in order to further stiffen the package. In order to avoid that the side walls 12, 14 are welded together with each other in said lower corners when arranging said ribbings 92, 94, a non-weldable material such as e.g. Teflon may be arranged between the bottom lamellae 18, 20 at ribbing with press jaws.

The package may be used for fluid material such as e.g. fluids or viscous products such as e.g. marmalade or similar.

By using a package, the amount of material which is needed for the production of the package is minimised. For large packages one may reach a relation of the order of magnitude 1 gram packing material per 100 gram material which has been packed in the package.

In order to give the package additional firmness, a stiffening part such as a tape may be applied on the underside of the package after filling. The stiffening part may also be fastened using a heat activated glue with lower melting point than the melting point of the foil.

The package is preferably laid flat and “void of air” when filling material in order to avoid froth forming.

The invention thus relates to a package for a fluid material, the package 8 comprising a bag of flexible sheet material 2, where the package 8 comprises two opposite side walls 12, 14 and a bottom 22 which bottom 22 before filling of material presents two fields 18, 20 received between the side walls 12, 14, and where further the bottom 22 and the side walls 12, 14 are tightly sealed with each other along the side edges 3, 5 of the package 8, where a creased section 13, 15 is arranged along the transition edges 50, 52 between the bottom 22 of the package 8 and its respective side walls 12, 14 for forming of a series of to each other connected lamellae 54, 56; 58, 60 whereby the side walls 12, 14 are kept substantially vertical and substantially perpendicular to the bottom 22 along the transition edges 50, 52 when the package 8 is filled with the fluid material 9 wherein the package 8 is stabilised against tipping over.

The invention further relates to a method of producing a stabilised package 8 for a fluid material, where it comprises the steps of:

forming a flat laid continuous web 2 of flexible material 1 of W-profile corresponding to the two opposite side walls 12, 14 of the package 8 and its bottom 22 which bottom 22 before filling of material comprises two fields 18, 20 received between the side walls 12, 14,

creasing at least a part of the lower part of the web 2 wherein a creased section 13, 15 along the transition edges 50, 52 between the bottom 22 of the package 8 and its respective side walls 12, 14 is arranged,

establish transversal sealing seams 4 at regular intervals along the web, and

cut the web with cuts along the sealing seams 4 to form individual packages 8.

As mentioned above, the method may according to further embodiments inter alia comprise the following steps one at a time or in combination with each other where this is possible:

creasing the lower part of the web between in each other engaging press jaws or toothed wheels 30, 32 which are displaced relative to the web 2 in its longitudinal direction,

establish transversal sealing seams 4 at regular intervals along the web by intermittent welding together of the web 2,

sealing the package 8 after filling by welding together of the neck (10) of the package (8).

1. Package for a fluid material, the package (8) comprising a bag of flexible sheet material (2), where the package (8) comprises two opposite side walls (12, 14) and a bottom (22) which bottom (22) before filling of material presents two fields (18, 20) received between the side walls (12, 14), and where further the bottom (22) and the side walls (12, 14) are tightly sealed with each other along the side edges (3, 5) of the package (8), characterized in, that a creased section (13, 15) is arranged along the transition edges (50, 52) between the bottom (22) of the package (8) and its respective side walls (12, 14) for forming of a series of to each other connected lamellae (54, 56; 58, 60) whereby the side walls (12, 14) are kept substantially vertical and substantially perpendicular to the bottom (22) along the transition edges (50, 52) when the package (8) is filled with the fluid material (9) wherein the package (8) is stabilised against tipping over.

2. Package as claimed in claim 1, characterized in, that the creased section (13, 15) is arranged in the form of elongated lamellae (54, 56, 58, 60) arranged mutually alternating creased, where the connection lines (55, 59) between the lamellae (54, 56; 58, 60) extend with substantially right angles against the transition edges (50, 52) between the bottom (22) of the package (8) and its respective side walls (12, 14).

3. Package as claimed in claim 1, characterized in, that the creased section (13, 15) is arranged along at least a part of the transition edges (50, 52) between the bottom (22) of the package (8) and its respective side walls (12, 14).

4. Package as claimed in claim 1, characterized in, that the package (8) is sealed by that the upper edges of the side walls (12, 14) are joined together with each other and that thereby formed flaps (66, 68) at the upper end of the package (8) are folded in and fastened to the upper surface (70) or the side envelop surface (72, 74) of the package (8) in order to further stiffen the package (8) and its upper part.

5. Package as claimed in claim 1, characterized in, that the package is arranged with a handle (80) comprising an insert (82) in the form of a support device inserted in a pocket (84) on the package (8).

6. Package as claimed in claim 1, characterized in, that a band shaped handle (80) is fastened at the upper end of the package (8).

7. Package as claimed in claim 1, characterized in, that the package comprises a separate emptying device (86, 88) arranged fastened to the package (8).

8. Method of producing a stabilised package for a fluid material, characterized in, that it comprises the steps of:
forming a flat laid continuous web (2) of flexible material (1) of W-profile corresponding to the two opposite side walls (12, 14) of the package (8) and its bottom (22) which bottom (22) before filling of material comprises two fields (18, 20) received between the side walls (12, 14),
creasing at least a part of the lower part of the web (2) wherein a creased section (13, 15) along the transition edges (50, 52) between the bottom (22) of the package (8) and its respective side walls (12, 14) is arranged,
establishing transversal sealing seams (4) at regular intervals along the web, and
cutting the web with cuts along the sealing seams (4) to form individual packages (8).

9. Method as claimed in claim 8, characterized by the steps of:
creasing the lower part of the web between in each other engaging press jaws or toothed wheels (30, 32) which are displaced in relation to the web (2) in its longitudinal direction.

10. Method as claimed in claim 8, characterized by the steps of:
establishing transversal sealing seams (4) at regular intervals along the web by intermittent welding together of the web (2), and
sealing the package (8) after filling by welding together of the neck (10) of the package (8).
